(19) United States
(12) Patent Application Publication
(10) Pub. No.: US 2011/0210821 A1
(43) Pub. Date: Sep. 1, 2011

(54) DEVICE FOR AUTOMATICALLY UNLOCKING AN OPENABLE PANEL OF A MOTOR VEHICLE

(75) Inventor: Frederic Gehin, Creteil Cedex (FR)

(73) Assignee: VALEO SECURITE HABITACLE, Creteil Cedex (FR)

(21) Appl. No.: 13/120,595

(22) PCT Filed: Oct. 1, 2009
(86) PCT No.: PCT/EP2009/062771

§ 371 Date: May 17, 2011

(30) Foreign Application Priority Data
Oct. 1, 2008 (FR) 08/05457

(51) Int. Cl. G05B 19/00

(52) U.S. Cl. 340/5.64

(57) ABSTRACT

The present invention relates to a device for automatically locking and/or unlocking at least one openable panel (3) of a motor vehicle (1) comprising a remote-opening system (4) comprising a central processing unit (5) designed to be installed inside the vehicle, and a portable identification element (17), said central processing unit (5) being capable of authenticating by radiofrequency the portable identification element (17). Said device further comprises means (13) for the remote optical recognition of a predetermined movement of part of the body for locking and/or unlocking said openable panel or panels in front of which the movement has been executed in the event of positive recognition of the movement and in that the central processing unit comprises activation means (11) for activating said remote optical recognition means (13) when the portable identification element (17) is located within a predefined perimeter (19) around the vehicle (1).

The present invention relates to a device for automatically unlocking at least one opening of a motor vehicle.

The device according to the invention applies, for example, to a vehicle equipped with a radiofrequency receiver intended for a user of the vehicle provided with an identification member to be able to enter the vehicle without having to do anything in the immediate environment of the vehicle.

In the state of the art, the devices allowing access without doing anything more often than not comprise an approach sensor coupled to a hands-free access system so that an authentication attempt is triggered only when the approach sensor detects the presence of a user. Thus, in the case where the authentication attempt is successful, the recognition device triggers the unlocking of one or more openings of the vehicle.

However, with interactive systems, problems of unwanted unlocking of the openings are sometimes encountered. Simply the presence of the badge wearer in the environment of the vehicle is sufficient in fact to unlock the doors and it happens that the interchanges between the badge and the emission/reception unit of the vehicle order the unlocking of the doors without the user wanting it or being aware of it.

Thus, if the system unlocks all the openings of the vehicle, there is the risk of an ill-intentioned person approaching the vehicle in order, for example, to steal objects from the vehicle.

Moreover, these hands-free access devices entail costly equipment and require a certain energy in order to perform a permanent scan of the environment. This energy consumption may, when the vehicle is stopped with the engine off, cause a premature discharging of the battery of the vehicle that might prevent the starting of said vehicle.

It is therefore one object of the present invention to overcome the abovementioned drawbacks of the state of the art and to provide a device for automatically locking and/or unlocking at least one opening of a motor vehicle by a remote control requiring limited equipment on board the vehicle, that makes it possible to avoid unwanted locking and/or unlocking.

Another object of the invention is to limit the battery consumption by optical recognition means by an improved triggering of said means. To this end, the invention relates not only to the systems of the hands-free system type, but also to the devices for opening doors by one-way radiofrequency transmission from a portable identification member to a computer located in the vehicle, such as a central processing unit.

To this end, the subject of the invention is a device for automatically locking and/or unlocking at least one opening of a motor vehicle comprising a remote-opening system comprising a central processing unit intended to be installed inside the vehicle, a portable identification member, said central processing unit being capable of authenticating by radio frequency the identification member, characterized in that it further comprises optical means for remotely recognizing a predetermined movement of a part of the body for locking and/or unlocking said at least one opening in front of which the movement has been executed in the case of positive recognition of the movement and in that the central processing unit comprises activation means for activating said remote optical recognition means when a radiofrequency signal emitted by the portable identification member is received by the central processing unit.

According to a first embodiment, the activation means are controlled in response to the authentication of the portable identification member.

According to a first embodiment, the portable identification member is configured to cyclically emit a radiofrequency signal when an activation command from said identification member is activated by the user.

According to another embodiment, the central processing unit comprises means of estimating the distance between the vehicle and the portable identification member.

According to an additional embodiment, said means of estimating the distance between the vehicle and the portable identification member are based on the evaluation of the power of the radiofrequency signal emitted by the portable identification member and received by the central processing unit.

According to a supplementary embodiment, said means of estimating the distance between the vehicle and the portable identification member comprise ultrasound transducers and are activated by the reception of a radiofrequency signal emitted by the portable identification member.

According to a supplementary embodiment, said remote optical recognition means are activated when the portable identification member is located within a predefined perimeter around the vehicle.

According to another embodiment, the radiofrequency signal consists of high-frequency waves between 50 and 500 Mhz.

According to an additional embodiment, the identification member is configured to interrupt the emission of the radiofrequency signal after a predetermined time.

According to a supplementary embodiment, the identification member is configured to interrupt the emission of the radiofrequency signal when a deactivation command from said identification member is activated by the user.

According to another embodiment, the central processing unit is configured to disable the radiofrequency signals emitted by the identifying member after activation of said remote optical recognition means until another opening of the motor vehicle opens.

According to an additional embodiment, the portable identification member comprises a rechargeable battery.

According to a supplementary embodiment, the identification member comprises means of measuring the level of the battery and disabling means for disabling the emission of the radiofrequency signals intended to activate said remote optical recognition means if the level of the battery is below a predetermined level.

Other features and advantages of the invention will become apparent from the following description, with reference to the appended drawings which represent, indicatively but in a nonlimiting way, a possible embodiment thereof.

In these drawings:

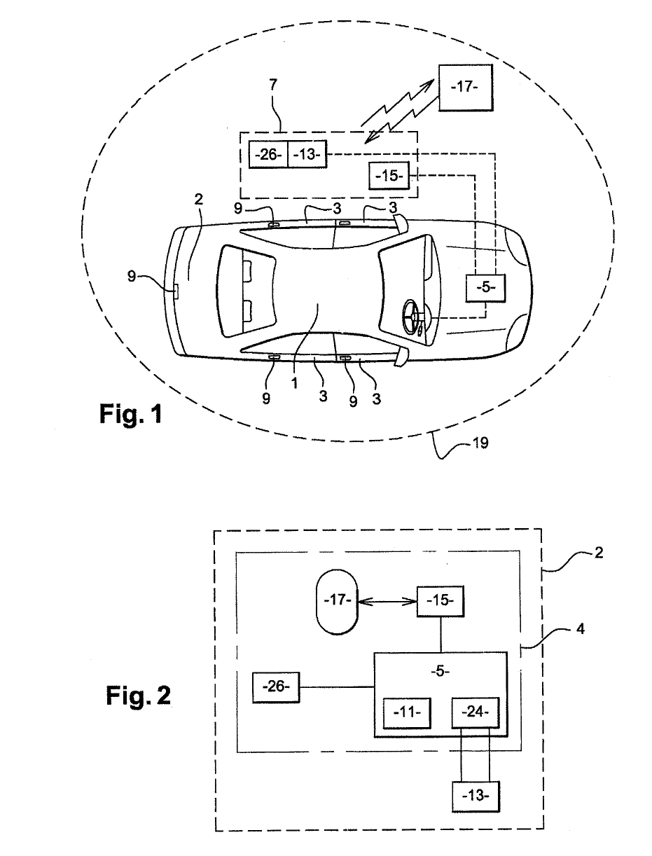

FIG. 1 is a plan view of a vehicle equipped with a device according to the invention,

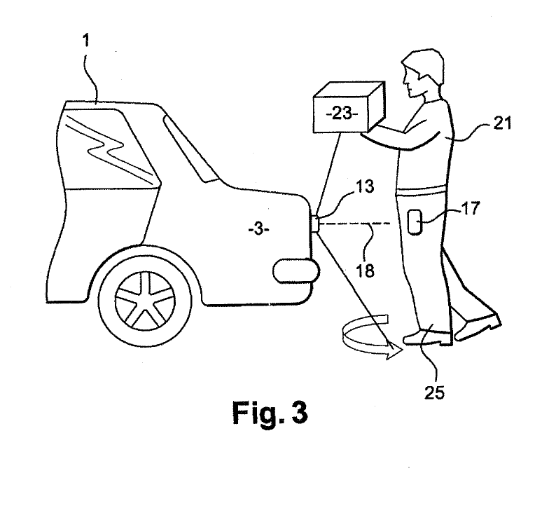

FIG. 2 is a block diagram of the device according to the invention,

FIG. 3 is a side view of the vehicle of FIG. 1 with a driver wanting to open the trunk of the vehicle.

The expression “identification member” corresponds to any type of equipment capable of emitting signals allowing for identification by a device external to the identification member, in particular a remote control.

The term “opening” covers the hinged or sliding side doors and the trunk or tailgate of the vehicle.

The various elements of the device according to the invention will now be described in more detail with reference to the figures. In these figures, identical elements are given the same reference numbers.

FIG. 1 shows a motor vehicle 1 equipped with a device according to the invention for automatically unlocking one or more openings 3 of the motor vehicle 1. This device 2, represented in detail in FIG. 2, comprises a remote-opening system 4 comprising a central processing unit 5 intended to be installed inside the vehicle 1 which is linked to peripheral devices 7 installed, for example, at the level of or in each handle 9 (FIG. 1). The term “handle” 9 should be understood to mean not only the handles of the doors but, obviously, also that of a tailgate or of a trunk of the vehicle.

The peripheral devices 7 comprise, for example, remote optical recognition means such as a camera 13 for allowing the recognition of a predetermined movement of a part of the body of a user, in particular the movement of a foot, preferably the rotation of a foot or the direction of rotation of a foot, and at least one radiofrequency receiver 15 for allowing for the reception of radio signals emitted by a portable identification member 17 worn by the user 21 of the vehicle 1 (FIG. 3).

According to an alternative embodiment which is not represented, the use of an infrared sensor as known from document US 2006/044800 can be considered for following and recognizing the movements of a user.

Obviously, the at least one receiver 15 may also be arranged in other places of the vehicle independently of the handles, such as, for example, the roof of the vehicle or in the uprights or the bumpers.

Regarding the cameras 13, these may be black and white or color cameras. They are activated by activation means 11 located in the central processing unit 5 and are advantageously arranged so that the optical axis 18 is perpendicular to the lateral or rear planes of the vehicle 1 to avoid any masking effect with respect to the camera 13 when facing the opening.

The identification member 17 is, for example, produced in the form of a badge or a remote control and comprises means of emitting radiofrequency signals to allow remote radiofrequency communication with the radiofrequency receiver 15 linked to the central processing unit 5. The emission of radiofrequency signals is triggered by the activation of a command located on the identification member 17. For example, if the identification member 17 is a remote control, pressing a command button will cause radiofrequency signals to be emitted for a predetermined time or until the command is deactivated, by pressing the command button once again, for example.

This communication is used in particular to authenticate the member 17, that is to say, to check that said member 17 is indeed associated with the vehicle 1.

The authentication is performed by analysis of the radiofrequency signals received on the receiver 15.

Moreover, the portable identification member 17 comprises, as energy source, a battery or a storage cell and preferably means of determining the energy level of this source. Furthermore, the emission of radiofrequency signals in order to allow for automatic opening of an opening 3 of the motor vehicle 1 as described in the present invention may be considered as a convenience function. Thus, in the case where the energy level of the battery or of the storage cell of the identification member 17 is below a predetermined value, the portable identification member 17 disables said convenience function in order to conserve the energy available for the essential functions such as the manual unlocking of the openings 3 of the vehicle 1.

In another embodiment, the portable identification member 17 has a module dedicated to conventional authentication by radiofrequency emission for the opening of the doors of the vehicle, this module being powered by a first battery. It furthermore comprises a module dedicated to the present convenience function, the module being powered by a rechargeable battery which is then different from the first battery, in order for the draining of the rechargeable battery to provoke only the stoppage of the convenience function.

In a preferred embodiment, the vehicle comprises means of measuring the charge level of the battery of the vehicle, which are capable of comparing this level with a reference level. These means, for example, consist of the central processing unit 5. When the charge level of the battery crosses below the reference level, the central processing unit 5 then orders the present camera starting functionality to be stopped.

To this end, the central processing unit 5 causes identification module interrogation functions and/or reception and recognition of a signal coming from this identification module and specifically intended to start the camera to be stopped.

For such a disabling of the processing, which takes place inside the vehicle and is intended to start up the camera, a portion of the consumption applied to the battery of the vehicle is cancelled and the remaining life of the battery is thereby extended.

In order to better understand the present invention, an example of use of the present invention will now be described with reference to FIG. 3.

A user 21 of a motor vehicle 1 provided with an identification member 17 wants to place an object that has to be carried using both arms in his vehicle trunk.

Firstly, the user will activate the emission of radiofrequency signals by pressing the command button provided for this purpose on the identification member 17. Preferably, this emission is done cyclically. Since the range of the radiofrequency signals is limited, these signals will be received by a radiofrequency receiver installed on the vehicle only when the user is in an area 19 close to the vehicle (FIG. 1). The size of this area 19 depends, among other things, on the power of the emitted signals.

The user then places the identification member 17 in his pocket. He then has his hands free and can thus take the object that he wants to place in his vehicle trunk. By approaching his vehicle, the user will enter the area 19 corresponding to the range of the radiofrequency signals emitted by the identification member 17. These signals will therefore be received by the radiofrequency receiver 15 located on the vehicle 1 and then transmitted to the central processing unit 5 and analyzed in order to authenticate the origin of said signals and check that they correspond to those emitted by the identification member 17 that corresponds to the vehicle 1.

In case of positive authentication, the remote-opening system 4 is placed in a “ready to unlock” state for all the openings 3 of the vehicle. Furthermore, the analysis of the received signals may also lead to an estimation of the distance at which the user is located, by measuring, for example, the power of these signals and by comparing with a database of received powers according to the distance between the sender and the receiver. In this case, the remote-opening system 4 is placed in a “ready to unlock” state only if the distance is less than a predefined distance, for example 5 meters. Furthermore, an additional condition, such as the approaching of the user, may also be introduced in order to avoid the activation of the optical recognition means when the identifier is stored in a perimeter close to the vehicle. The consequence of the “ready to unlock” state is that the optical recognition means, such as, for example, cameras 13, are activated and begin to record images. The optical means for remotely recognizing a predetermined movement of a part of the body, notably the camera 13, are therefore only activated by the central processing unit 5 after a positive authentication, which allows for an optimized management of the energy of the battery of the vehicle 1. Thus, these cameras consume energy only when necessary, in other words, when the user 21 is in proximity to the vehicle 1.

Alternatively, in case of positive authentication, an ultrasound measuring system (not represented) may be activated in order to determine the distance at which the user is located, this system then triggering the “ready to unlock” state when the user 21 is close to the vehicle 1.

Preferably, firstly, the opening 3 in front of which the user 21 is located is identified via cameras 13 and an image processing computer 24 in the central processing unit 5.

Once the central processing unit 5 has determined the opening concerned, the cameras 13 associated with the other openings stop recording images to free up processing capability for the image processing computer 24 and the received radiofrequency signals are disabled until a predefined event such as the opening of another door for example.

Alternatively, an approach sensor 26 is also placed in the handle or in proximity to the latter to activate only the camera of the opening concerned.

In this example, the opening 3 concerned is the trunk of the motor vehicle 1.

Then, a predetermined movement of a part of the body is remotely optically recognized by the camera 13. This step of remote optical recognition by a camera 13 of a predetermined movement of a part of the body is preferably performed on the basis of gray level images to optimize the capability/cost pairing of the image processing computer 24.

It has proven wise to be able to recognize the movement of a foot 25, in particular the rotational movement or the direction of rotation of the foot of the user. In practice, the movement of a foot 25 is discrete while being recognizable for the camera and the image processing computer.

In case of positive recognition of the movement 25, the opening 3 in front of which the movement 25 has been executed, is unlocked, that is to say, the lock is unlocked.

If the trunk of the vehicle is equipped with suitable springs automatically impelling it to an open position, then the trunk of the vehicle is opened.

In the case where the opening is equipped with a motor-driven unit for assisting in opening the opening (not represented), the central processing unit 5 triggers an automatic opening of the opening via the motor-driven assistance unit.

Thus, by virtue of the features of the present invention, the user can easily and securely access his vehicle. The system is also differentiated by simplified equipment and optimized management of the energy consumption.

The exemplary embodiments described hereinabove for the opening of a motor vehicle opening are, in a variant, applied to the closing of an opening, with the same steps and the same means, for example.

The central processing unit advantageously identifies the open/closed state of the opening at the very moment when the same steps are implemented, and respectively triggers the closing or opening of the opening depending on its respective open or closed state.

The opening that can be controlled by virtue of the means described is not limited to a motor vehicle trunk opening. It may consist of a side door, a window, an opening roof or any other type of opening adapted to a vehicle of a type known per se.

For example, the present means may be implemented in the context of the invention for the locking and/or unlocking and/or for the motor-driven opening or closing of several openings simultaneously.

The invention applies, for example, to the closing and/or opening of the windows of the vehicle with the opening roof of this same vehicle, simultaneously.

1. A device for automatically locking and/or unlocking at least one opening of a motor vehicle comprising:
a remote-opening system comprising a central processing unit intended to be installed inside the vehicle;
a portable identification member, said central processing unit being capable of authenticating by radio frequency the identification member; and
optical means for remotely recognizing a predetermined movement of a part of the body for locking and/or unlocking said at least one opening in front of which the movement has been executed in the case of positive recognition of the movement, and wherein the central processing unit comprises activation means for activating said remote optical recognition means when a radiofrequency signal emitted by the portable identification member is received by the central processing unit.

2. The device as claimed in claim 1, wherein the activation means are controlled in response to the authentication of the portable identification member.

3. The device as claimed in claim 1, wherein the portable identification member is configured to cyclically emit a radiofrequency signal when an activation command from said identification member is activated by a user.

4. The device as claimed in claim 1, wherein the central processing unit comprises means of estimating the distance between the vehicle and the identification member.

5. The device as claimed in claim 4, wherein said means of estimating the distance between the vehicle and the identification member are based on the evaluation of the power of the radiofrequency signal emitted by the portable identification member and received by the central processing unit.

6. The device as claimed in claim 4, wherein said means of estimating the distance between the vehicle and the portable identification member comprise ultrasound transducers and are activated by the reception of a radiofrequency signal emitted by the identification member.

7. The device as claimed in claim 5, wherein said remote optical recognition means are activated when the portable identification member is located within a predefined perimeter around the vehicle.

8. The device for automatically locking and/or unlocking at least one opening (3) of a motor vehicle as claimed in one of the preceding claims, characterized in that the radiofrequency signal consists of high-frequency waves between 50 and 500 Mhz.

9. The device as claimed in claim 1, wherein the identification member is configured to interrupt the emission of the radiofrequency signal after a predetermined time.

10. The device as claimed in claim 1, wherein the portable identification member is configured to interrupt the emission of the radiofrequency signal when a deactivation command from said identification member is activated by a user.

11. The device as claimed in claim 1, wherein the central processing unit is configured to disable the radiofrequency signals emitted by the portable identifying member after activation of said remote optical recognition means until another opening of the motor vehicle opens.

12. The device as claimed in claim 1, wherein the portable identification member comprises a rechargeable battery.

13. The device as claimed in claim 12, wherein the portable identification member comprises means of measuring the level of the rechargeable battery and disabling means for disabling the emission of radiofrequency signals intended to activate said remote optical recognition means when the level of the rechargeable battery is below a predetermined level.
